(19) United States
(12) Patent Application Publication
(10) Pub. No.: US 2014/0244928 A1
(43) Pub. Date: Aug. 28, 2014

(54) METHOD AND SYSTEM TO PROVIDE DATA PROTECTION TO RAID 0/ OR DEGRADED REDUNDANT VIRTUAL DISK

(71) Applicant: LSI CORPORATION, San Jose, CA (US)

(72) Inventors: Prafull Tiwari, Bangalore (IN); Madan Mohan Munireddy, Bangalore (IN)

(73) Assignee: LSI CORPORATION, San Jose, CA (US)

(21) Appl. No.: 13/804,632

(22) Filed: Mar. 14, 2013

(30) Foreign Application Priority Data
Feb. 28, 2013 (IN) 892/CHE/2013

(51) Int. Cl. G06F 3/06

(52) U.S. Cl. CPC G06F 3/0689
USPC 711/114

(57) ABSTRACT

Disclosed is a system and method for providing redundancy to RAID 0 virtual disks by utilizing any right sized physical disk in the SAS domain. The system and method restore redundancy in a degraded redundant virtual disk. This may be done even in the absence of a configured hot spare.

### FIELD OF THE INVENTION

The field of the invention relates generally to performance of RAID virtual disks.

### BACKGROUND OF THE INVENTION

Mass storage systems continue to provide increased storage capacities to satisfy user demands. Photo and movie storage, and photo and movie sharing are examples of applications that fuel the growth in demand for larger and larger storage systems. A solution to these increasing demands is the use of arrays of multiple inexpensive disks.

Multiple disk drive components may be combined into logical units. Data may then be distributed across the drives in one of several ways. RAID is an umbrella term for computer storage schemes that can divide and replicate data among multiple physical drives. The physical drives are considered to be in groups of drives, or disks. Typically the array can be accessed by an operating system, or controller, as a single drive.

A RAID 0 (also known as a stripe set or striped volume splits data evenly across two or more disks without parity information for speed. RAID 0 was not one of the original RAID levels and provides no data redundancy. RAID 0 is normally used to increase performance, although it can also be used as a way to create a large logical disk out of two or more physical disks. An idealized implementation of RAID 0 would split I/O operations into equal-sized blocks and spread them evenly across two disks. RAID 0 implementations with more than two disks are also possible, though the group reliability decreases with member size. Data redundancy occurs in database systems which have a field that is repeated in two or more tables.

### SUMMARY OF THE INVENTION

An embodiment of the invention may comprise a method of providing redundancy to a RAID 0 virtual disk on a controller, the method comprising: establishing a table, the table comprising information about physical drives; determining that a drive in a RAID 0 virtual disk is experiencing SMART errors; hierarchically determining at least one drive eligible for COPYBACK from the drive experiencing SMART errors; selecting a drive from the eligible drives; and performing a COPYBACK operation to the selected drive from the drive experiencing SMART errors.

An embodiment of the invention may further comprise a system for providing redundancy to a RAID 0 virtual disk on a controller, the system comprising: a RAID 0 virtual disk comprising at least two member disks; at least one eligible disk for a COPYBACK operation; and an algorithm for determining and selecting one of the at least one eligible disk.

### BRIEF DESCRIPTION OF THE DRAWINGS

FIG. 1 is a diagram of a failing drive replacement using a configured GHSP or an un-configured good drive in the SAS domain.

FIG. 2 is a diagram of a failing drive replacement using a configured physical rive from a redundant virtual disk in the SAS domain.

FIG. 3 is a flow chart of an algorithm to provide redundancy to RAID 0 using physical drives in the SAS domain

FIG. 4 is a table showing information regarding physical disks in a NVRAM.

### DETAILED DESCRIPTION OF THE EMBODIMENTS

Serial Attached SCSI (SAS) is a point-to-point serial protocol that is used to move data to and from computer storage devices such as hard drives and tape drives. An SAS domain is the SAS version of a SCSI domain—it consists of a set of SAS devices that communicate with one another through of a service delivery subsystem. Each SAS port in a SAS domain has a SCSI port identifier that identifies the port uniquely within the SAS domain. It is assigned by the device manufacturer, like an Ethernet device's MAC address, and is typically world-wide unique as well. SAS devices use these port identifiers to address communications to each other. In addition, every SAS device has a SCSI device name, which identifies the SAS device uniquely in the world. One doesn't often see these device names because the port identifiers tend to identify the device sufficiently.

In a RAID 0 system, data is split into blocks that get written across all the drives in the array. Instead of having to wait on the system to write 256 k to one disk, a RAID 0 system can simultaneously write 64 k to each of four different disks, offering superior I/O performance. This performance can be enhanced further by using multiple disk controllers. Each disk in a RAID 0 stripe is of the same size, since I/O requests are interleaved to read or write to multiple disks in parallel.

In an embodiment of the invention, a RAID 0 virtual disk is provided redundancy by utilizing any right sized physical disk in the SAS domain. Even in the absence of a configured hot spare, redundancy may be restored in a degraded redundant virtual disk. As is understood, drive failures may occur due to SMART errors in a RAID member disk. A RAID 0 drive failure may occur and may also occur in any redundant virtual disk that may already be degraded.

A scan is made of all the current RAID configurations present on a system. This may be a system such as an LSI MegaRAID system, or any other RAID system. The scan may be of the controller card on which the system resides. The scan will detect the presence of one or more RAID 0 virtual disks. Also, any other redundant virtual disks present on the RAID controller card will be detected.

A table is maintained in non-volatile RAM. The table provides details of physical disks in the SAS domain, including disks part of redundant virtual disks, configured hot spare disks and un-configured good drives. The table contains current power status of physical disks. This may be whether the physical disk is in a power save mode, or otherwise. The table may also contain data on drive activity using a Driver Performance Monitor (DPM). The table is updateable each time a scan is performed or whenever any change occurs in the current configuration. Changes in the configuration may include addition of a virtual disk, removal of a virtual disk, addition of a physical disk, removal of a physical disk, addition of a hot spare, removal of a hot spare. It is understood that there are many additional occurrences that may comprise a configuration change.

In an SAS domain, SMART errors may occur. SMART (Self-Monitoring, Analysis and Reporting Technology) is a monitoring system for computer hard disk drives to detect and report on various indicators of reliability, in the hope of anticipating failures. When a failure is anticipated by SMART, the user may choose to replace the drive to avoid unexpected outage and data loss. Firmware is able to detect when a member disk of a RAID 0 virtual disk is experiencing SMART errors. If such an error is detected, the firmware will attempt to determining if any right sized global hot-spare is present. This may be done by referring to the table. If a right sized global hot-spare is configured, a COPYBACK operation may be performed. However, if no right sized global hot-spare is configured, the table is referenced by firmware to determine if any right sized un-configured good drive is present to start a COPYBACK operation.

It may be that there is no right sized global hot-spare or an un-configured good drive present in the SAS domain. If such is the state of the system, firmware will refer to the NVRAM table to determine the presence of any physical disks which are part of redundant virtual disks. An algorithm may be used to determine if any of the detected physical disks from the NVRAM table are in power save mode.

The algorithm creates a list of the physical disk and determines which physical disk is either the least used physical disk or a physical disk which is in power save mode for a long duration. As an example, the algorithm may detect that there are two right sized physical disks that are part of a redundant VDs. One disk may be in a RAID 1 and the other disk may be in a RAID 6. Both detected disks are present and both disks are in power save mode. Preference is given to the physical disk which is part of the RAID 6. However, if both physical disks belong to the same RAID level, then the DPM is utilized to detect the drive activity of the respective disks. The drive showing the least recent activity is chosen. It is understood that the least recent activity can mean a variety of things. It can mean the last used disk or it can mean the least used over a period of time, among others. The determination of what is least used can be an implementation and design decision.

When a disk is chosen by the algorithm, that disk will be identified in the system as offline. The virtual disk which had the chosen physical disk will be marked as degraded or partially degraded due to the loss of the disk. The chosen physical disk will be used for a COPYBACK operation. The data from the failing disk of the RAID 0 virtual disk, which experienced the SMART error(s), is used for the COPYBACK operation. Any un-configured good drive which is replaced can be used to rebuild the identified degraded, or partially degraded, virtual disk.

It is understood that the algorithm may not identify any disk in power save mode. In such a case, the algorithm will search for a right sized physical disk which is part of a redundant virtual disk. The algorithm will select the best physical disk which is part of a redundant virtual disk and which is the currently used. The least currently used can be identified as discussed above. As an example, the algorithm may detect that there are two right sized physical disks present. Preference will be given to the physical disk which is part of a RAID 6 virtual disk as compared to other physical disks which may be part of a RAID 1 virtual disk. If both physical disks belong to the same RAID level, then the DPM detects which drive activity is the least of the available drives. It is understood that the least recent activity can mean a variety of things. It can mean the last used disk or it can mean the least used over a period of time, among others. The determination of what is least used can be an implementation and design decision.

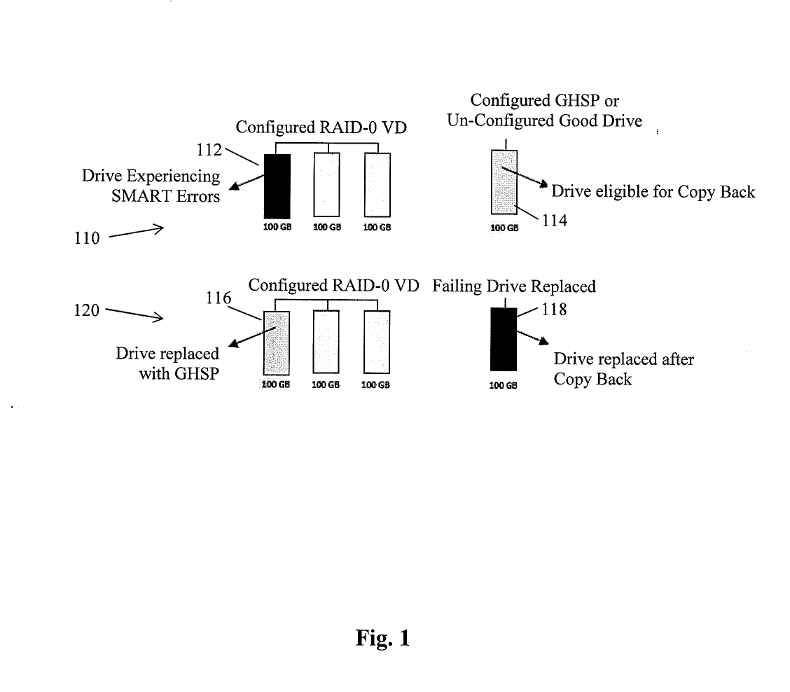

FIG. 1 is a diagram of a failing drive replacement using a configured GHSP or an un-configured good drive in the SAS domain. A first RAID 0 virtual disk 110 is shown with three 100 GB disks. It is understood that the disks do not have to be 100 GB. One of the drives 112 is experiencing one or more SMART errors. A global hot-spare 114, which is right sized, is detected by firmware. It is understood that the global hot-spare 114 may also be an un-configured good drive. A COPYBACK operation is performed copying the data from the drive with SMART errors 112 to the configured global hot-spare drive 114. A resulting RAID 0 virtual disk 120 is shown with the replacement configured global hot-spare drive 116. The failing drive 118 is replaced and removed from the RAID 0 virtual disk.

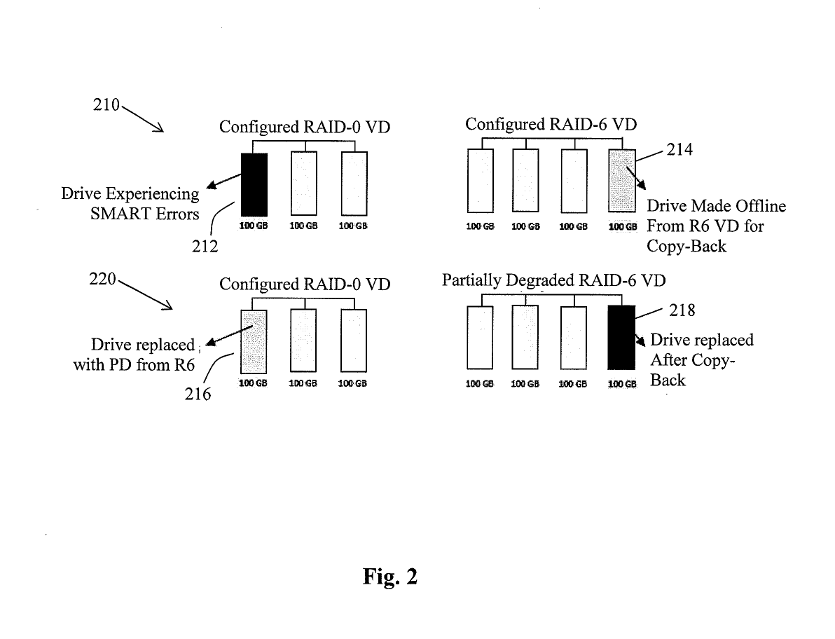

FIG. 2 is a diagram of a failing drive replacement using a configured physical drive from a redundant virtual disk in the SAS domain. A first RAID 0 virtual disk 210 is shown with three 100 GB disks. It is understood that the disks do not have to be 100 GB. One of the drives 212 is experiencing one or more SMART errors. An algorithm (not shown) detects at least one right sized physical disk 214 that is part of a RAID 6 virtual disk. It is understood that the algorithm may detect additional disks, such as a RAID 1 disk suitable for COPYBACK. However, for the purposes of simplicity, only the RAID 6 disk is shown in FIG. 2. It is also understood that the algorithm may detect additional RAID 6 disks and the least active disk would be chosen for COPYBACK. In either situation, only the chosen RAID 6 disk is shown.

The chosen RAID 6 drive 214 is marked as offline by the firmware. The virtual disk which had this chosen RAID 6 disk 214 is marked as degraded, or partially degraded, by the firmware. A COPYBACK operation from the failing disk 212 to the chosen RAID 6 disk 214 is performed. A resulting RAID 0 virtual disk 220 is shown with the replacement RAID 6 disk 216. The failing drive 212 is removed. The RAID 6 virtual disk has the removed disk 218 replaced with any un-configured good drive to rebuild the degraded, or partially degraded, virtual disk.

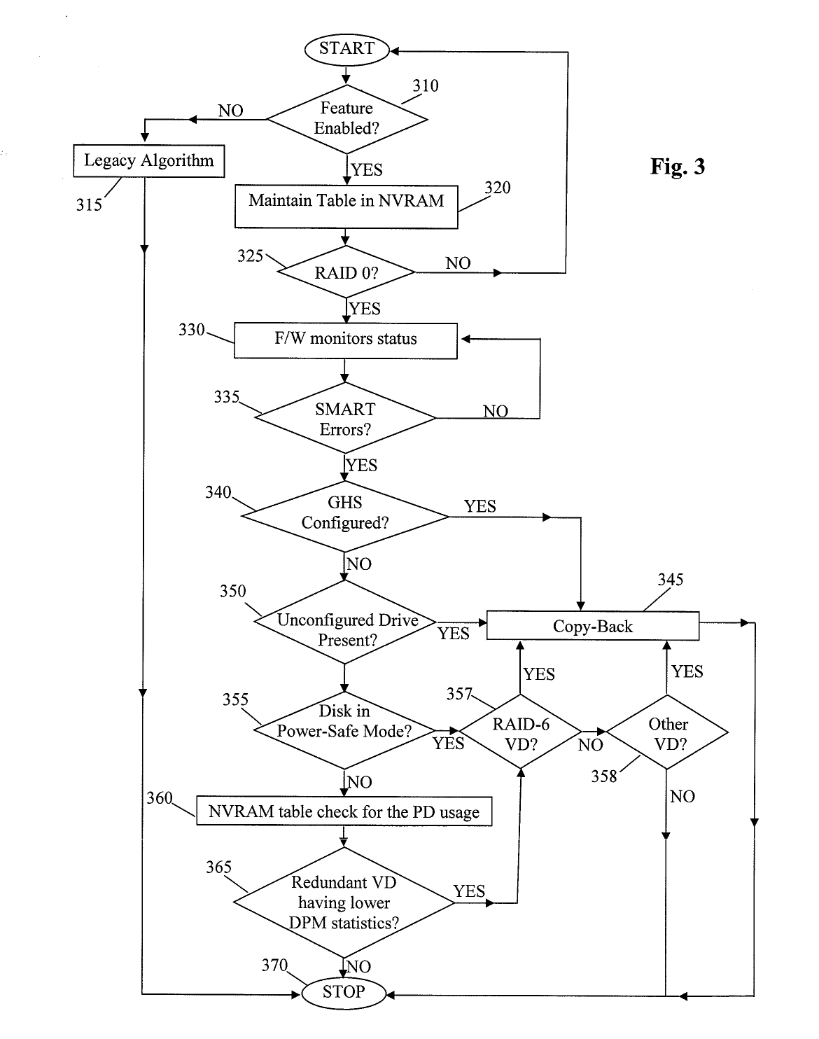

FIG. 3 is a flow chart of an algorithm to provide redundancy to RAID 0 using physical drives in the SAS domain. First, it is determined at step 310 whether the RAID 0 redundancy feature is implemented and active to enable COPYBACK. If the feature is not active, a legacy algorithm is utilized at step 315 in the RAID 0 virtual drive to operate the RAID 0 with no redundancy. If the feature is active, at step 320 a table is maintained in non-volatile RAM. As noted, the table contains details of physical disks in the SAS domain which may be suitable as COPYBACK disks for a RAID 0 disk with SMART errors. At step 325 it is determined if a RAID 0 virtual disk is configured on the controller. If not, the method returns to step 310. If there is a RAID 0 virtual disk configured, firmware will monitor the health status of physical disks in the RAID 0 virtual disk at step 330. At step 335 it is determined by the firmware whether any disk in the RAID 0 virtual disk is experiencing SMART errors. If not, the method returns to the firmware monitor step 330. If a disk is experiencing SMART errors as detected by the firmware, it is determined at step 340 if there is a right sized global hot-spare configured on the controller. If there is a right sized global hot-spare configured on the controller, a COPYBACK operation is performed from the drive experiencing SMART errors to the identified drive at step 345. If a right sized global hot-spare not configured on the controller, it is determined whether a right sized unconfigured good drive is present at step 350. If a right sized un-configured good drive is present, a COPYBACK operation is performed from the drive experiencing SMART errors to the identified drive at step 345. If a right sized un-configured good drive is not present, it is determined if any member disk in a redundant RAID virtual disk is in power save mode at step 355. If a member disk in a redundant RAID virtual disk is in power saver mode, it is determined if the identified drive is in a RAID 6 virtual disk at step 357. If the identified drive is in a RAID 6 virtual disk, then a COPYBACK operation is performed from the drive experiencing SMART errors to the identified drive at step 345. If the identified drive is not in a RAID 6 virtual disk, it is determined if the identified drive is in any other RAID virtual disk. If the identified drive is in another RAID virtual disk, then a COPYBACK operation is performed from the drive experiencing SMART errors to the identified drive at step 345. If there is no member disk in a redundant RAID virtual disk in power save mode, the non-volatile RAM table is checked for physical disk usage patterns using the DPM at step 360. At step 365 it is determined if any member disk in a redundant RAID virtual disk as having lower DPM statistics. If no disk is identified, then the method is stopped at step 370. If a disk is identified at step 365, it is determined if the identified drive is in a RAID 6 virtual disk at step 357. If the identified drive is in a RAID 6 virtual disk, then a COPYBACK operation is performed from the drive experiencing SMART errors to the identified drive at step 345.

It is noted that FIG. 3 shows a flowchart for a situation where a RAID 0 virtual disk is provided redundancy with the described method of the invention. It is understood that the same algorithm and pattern of disk identification is usable for any redundant virtual disk that is already degraded and one of the remaining member disks is experiencing SMART errors.

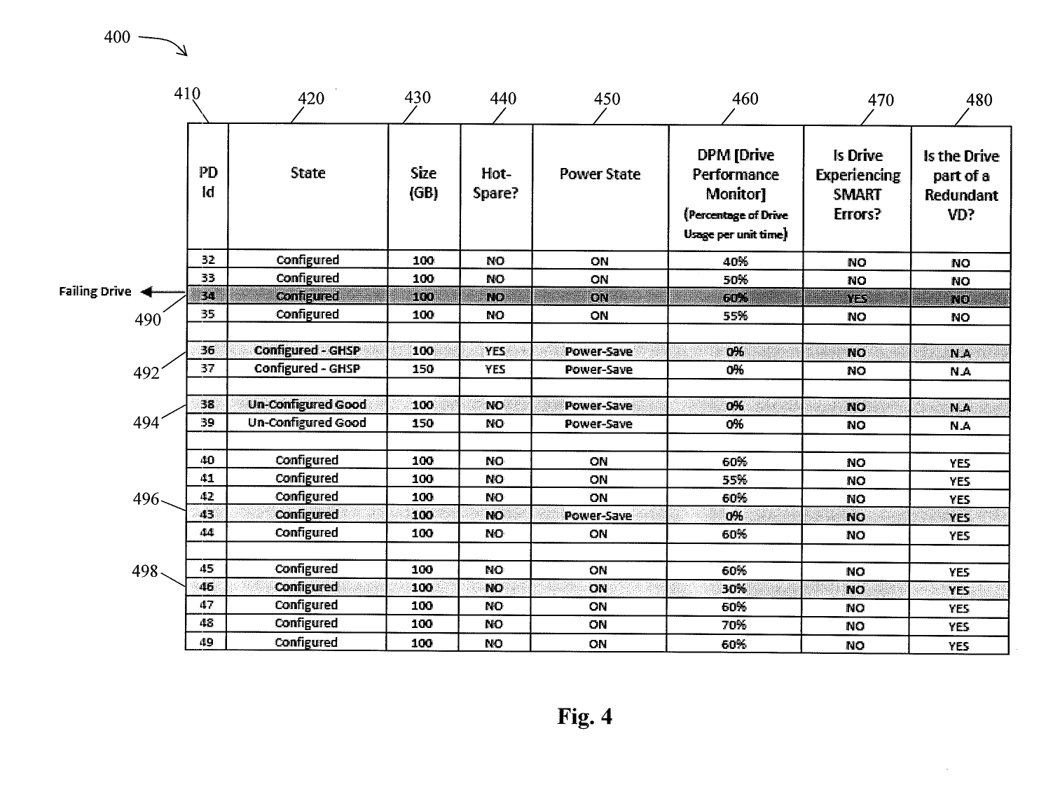

FIG. 4 is a table showing information regarding physical disks in a NVRAM. Table 400 comprises a plurality of statistics for possible available physical disks that could be used for a COPYBACK operation for a disk experiencing SMART errors. For each physical disk 410, there may be a configuration state 420, a disk size 430, a hot-spare identification 440, a power status 450, a DPM usage statistic 460, a SMART error status 470 and an identifier for whether the disk is part of a redundant virtual disk 480.

In the table 400, drive 34 490 is a failing drive as noted by the “YES” indication in the SMART errors identifier 470. Disk 36 492 is a configured global hot-spare drive. Drive 38 494 is an un-configured drive in power save mode. Drive 43 496 is a configured drive power save mode. Drive 46 498 is a configured drive which is not in power save mode, but which has the lowest usage indication 460. The identified drives are all suitable drives for COPYBACK and the method outlined in FIG. 4, and the remainder of the specification, will determine which drive to use for the COPYBACK. Drive 34 is determined to be experienced SMART errors at step 335. A right sized global hot-spare is detected at step 340. This is disk 36. A COPYBACK operation would be performed to disk 36 at step 345. Note that disk 37 is 150 GB and is therefore not a right sized global hot-spare.

If disk 36 were not part of table 400, disk 38 would be detected at step 350 as a right sized unconfigured good drive. Disk 38 would then be used for the COPYBACK. However, if disk 38 were not part of table 400, then disk 43 would be detected at step 355 as a member disk in a redundant virtual disk in power saver mode. Disk 43 would then be used for the COPYBACK. However, if disk 43 were not part of table 400, then disk 46 would be detected at step 365 as a member disk in a redundant virtual disk having the lowest DPM statistics. Disk 46 would then be used for the COPYBACK. If disk 46 were not part of table 400, then disk 41, which has the next lowest DPM usage statistic would be selected.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of providing redundancy to a RAID 0 virtual disk on a controller, said method comprising:
establishing a table, said table comprising information about physical drives;
determining that a drive in a RAID 0 virtual disk is experiencing SMART errors;
hierarchically determining at least one drive eligible for COPYBACK from said drive experiencing SMART errors;
selecting a drive from said eligible drives; and
performing a COPYBACK operation to said selected drive from said drive experiencing SMART errors.

2. The method of claim 1, wherein said hierarchically determining at least one drive eligible for COPYBACK comprises identifying a right sized global hot-spare on said controller.

3. The method of claim 2, wherein said hierarchically determining at least one drive eligible for COPYBACK further comprises identifying a right sized un-configured good drive on said controller.

4. The method of claim 3, wherein said hierarchically determining at least one drive eligible for COPYBACK further comprises identifying a member disk in a redundant virtual disk, said member disk being in power save mode.

5. The method of claim 4, wherein said hierarchically determining at least one drive eligible for COPYBACK further comprises determining if an identified member disk is in a RAID 6 virtual disk.

6. The method of claim 4, wherein said hierarchically determining at least one drive eligible for COPYBACK further comprises identifying a member disk in a redundant virtual disk, said member disk having a lowest usage rate.

7. The method of claim 1, wherein said table is maintained in non-volatile memory.

8. The method of claim 1, wherein said information comprises, for each physical disk in said table, a configuration status, a size, whether each physical disk is a hot-spare, a power status, a usage rate, whether said physical disk is experiencing SMART errors and whether said physical disk is part of a redundant virtual disk.

9. The method of claim 8, wherein firmware monitors said information in the table.

10. The method of claim 1, wherein said hierarchically determining at least one drive eligible for COPYBACK comprises:
determining if a right sized global hot-spare is on said controller;
if a right sized global hot-spare is not on said controller, determining if a right sized un-configured good drive is on said controller;
if a right sized un-configured good drive is not on said controller, determining if there is a member disk in a redundant virtual disk on said controller, said member disk being in power save mode; and
if a member disk in a redundant virtual disk, said disk being in power save mode, is not on said controller, determining if there is a member disk in a redundant virtual disk on the controller, said member disk having a lowest usage rate.

11. The method of claim 10, determining if there is a member disk in a redundant virtual disk on said controller further comprises determining if said redundant virtual disk is in a RAID 6 virtual disk.

12. A system for providing redundancy to a RAID 0 virtual disk on a controller, said system comprising:
a RAID 0 virtual disk comprising at least two member disks;
at least one eligible disk for a COPYBACK operation; and
an algorithm for determining and selecting one of said at least one eligible disk.

13. The system of claim 12, wherein said algorithm selects one of said at least one eligible disk from a table, said table comprising information about said at least one eligible disk.

14. The system of claim 13, wherein said information comprises, for each at least one eligible disk in said table, a configuration status, a size, whether each physical disk is a hot-spare, a power status, a usage rate, whether said physical disk is experiencing SMART errors and whether said physical disk is part of a redundant virtual disk.

15. The system of claim 12, wherein one of said at least one eligible disk comprises a right sized global hot-spare on said controller.

16. The system of claim 15, wherein one of said at least one eligible disk comprises a right sized un-configured good drive on said controller.

17. The system of claim 16, wherein one of said at least one eligible disk comprises a member disk in a redundant virtual disk, said member disk being in power save mode.

18. The system of claim 17, wherein said member disk being in power save mode is in a RAID 6 virtual disk.

19. The system of claim 17, wherein one of said at least one eligible disk comprises a member disk in a redundant virtual disk, said member disk having a lowest usage rate.
